(19) United States
(12) Patent Application Publication
(10) Pub. No.: US 2013/0077103 A1
(43) Pub. Date: Mar. 28, 2013

(54) COLOR CORRECTION PRINT APPARATUS AND PRINT CONTROL METHOD

(71) Applicant: Kenichiro Asako, Tokyo (JP)

(72) Inventor: Kenichiro Asako, Tokyo (JP)

(73) Assignee: CASIO COMPUTER CO., LTD., Tokyo (JP)

(21) Appl. No.: 13/617,513

(22) Filed: Sep. 14, 2012

(30) Foreign Application Priority Data
Sep. 26, 2011 (JP) 2011-208453

(51) Int. Cl. H04N 1/60

(52) U.S. Cl. 358/1.2

(57) ABSTRACT

A color correction print apparatus includes a print head and a print data correction unit. The print head prints an image on a printing surface. The print data correction unit corrects, on the basis of a first density value of a constituent color included in the image and a second density value of the constituent color of the printing surface, the first density value.

### BACKGROUND OF THE INVENTION

1. Field of the Invention

The present invention relates to a color correction print apparatus and a print control method.

2. Description of the Related Art

Conventionally, there is known a print apparatus which makes various colors by applying, for example, inks of yellow (Y; YELLOW), magenta (M; MAGENTA), cyan (C; CYAN), and the like (constituent colors) on top of each other, the inks being light transmissive inks.

In such a print apparatus, printing is expected to be performed, for example, on a white surface (printing surface) of paper, which is a print target, because white is regarded as the normal color for the surface of paper. Hence, in print data (original print data) of an image to be printed, the density values of the constituent colors of the image are set so that a target color of the image is developed when the image is printed on a white surface.

For example, Japanese Patent Application Laid-Open Publication (Translation of PCT Application) No. 2003-534083 discloses a nail print apparatus which is a print apparatus to print design images such as patterns or colors on the surfaces of nails of fingers of users, using light transmissive inks of constituent colors.

Such a nail print apparatus displays design images on a display unit thereof or the like, and prints a design image, which a user chooses from the displayed design images, on nails of the user. However, in the print data of the design image, the density values of the constituent colors are set so that the design image is printed so as to be nearly the same color as the design image displayed on the display unit or the like.

However, it is possible that a print apparatus performs printing on paper or the like on which some printing has been previously performed, or on color paper, recycled paper, or the like. In such a case, the printing surface of a print target (the surface of paper, for example) is not always white or the like which is regarded as the normal color for the print target. Hence, in this case, if printing is performed on the basis of print data generated on the assumption that the printing is performed on the printing surface of a print target having the normal color for the print target, a desired color cannot be developed, which raises a problem that high-quality printing cannot be performed.

For example, in the case of a nail print apparatus, the print target is nails of users. Colors of nails of users differ from one user to another, and hence the color of the print target is not always the normal color for nails (light pink, for example).

In particular, when nail printing has previously been performed on a nail, the color of the surface of the nail may be completely different from the normal color for nails (light pink, for example).

In such a case, if printing is performed on the nail using the original print data as it is, because light transmissive inks transmit the color of the surface of the print target (i.e. the nail), the color already applied onto the nail by the previous nail printing influences the color of a design image to be printed on the nail, which raises a problem that a color expected by a user cannot be developed.

The present invention is made in view of the circumstances. Objects of the present invention are to provide a color correction print apparatus and a print control method which can develop a color as expected, thereby performing high-quality printing regardless of the color of the printing surface of a print target.

### BRIEF SUMMARY OF THE INVENTION

According to a first aspect of the present invention, there is provided a color correction print apparatus including: a print head which prints an image on a printing surface; and a print data correction unit which corrects a first density value of a constituent color included in the image on the basis of a second density value of the constituent color of the printing surface and the first density value.

According to a second aspect of the present invention, there is provided a print control method including: obtaining a first density value of a constituent color included in an image to be printed on a printing surface; obtaining a second density value of the constituent color of the printing surface; and correcting the first density value on the basis of the first density value and the second density value.

### BRIEF DESCRIPTION OF THE SEVERAL VIEWS OF THE DRAWING

FIG. 1 is a perspective view conceptually showing a nail print apparatus as a color correction print apparatus in accordance with an embodiment of the present invention, the cover of the nail print apparatus being open;

FIG. 2 is a perspective view conceptually showing the main body of the nail print apparatus shown in FIG. 1;

FIG. 3 is a cross-sectional view showing a printing finger fixing unit of the nail print apparatus shown in FIG. 1, the printing finger fixing unit including a printing finger insertion unit where fingers as printing fingers are inserted and fixed;

FIG. 4 is a cross-sectional view of the nail print apparatus shown in FIG. 1, giving a view from the front;

FIG. 5 is a cross-sectional view of the nail print apparatus shown in FIG. 1, giving a view from the side;

FIG. 6 is a cross-sectional view of the principle part of the nail print apparatus schematically showing a relationship between fingers inserted into the printing finger insertion unit, a photographing unit, and a print unit of the nail print apparatus;

FIG. 7 is a block diagram showing a control configuration of the nail print apparatus in accordance with the embodiment;

FIG. 8A is an explanatory drawing conceptually showing calculation of a difference value between an image density value and a print target density value;

FIG. 8B is an explanatory drawing conceptually showing a density value of a printed image realized by corrected print data;

FIG. 9 is a flowchart showing print control processing in accordance with the embodiment;

FIG. 10 is an explanatory drawing schematically showing a case where a design image is to be printed on the nail of a printing finger without correction;

FIG. 11A shows a case where light magenta is printed on the surface of a nail;

FIG. 11B is an explanatory drawing showing correction performed when the design image shown in FIG. 10 is to be printed on the nail shown in FIG. 11A;

FIG. 12A shows a case where magenta is printed on the surface of a nail;

FIG. 12B is an explanatory drawing showing correction performed when the design image shown in FIG. 10 is to be printed on the nail shown in FIG. 12A;

FIG. 13A shows a case where light cyan is printed on the surface of a nail; and

FIG. 13B is an explanatory drawing showing correction performed when the design image shown in FIG. 10 is to be printed on the nail shown in FIG. 13A.

### DETAILED DESCRIPTION OF THE INVENTION

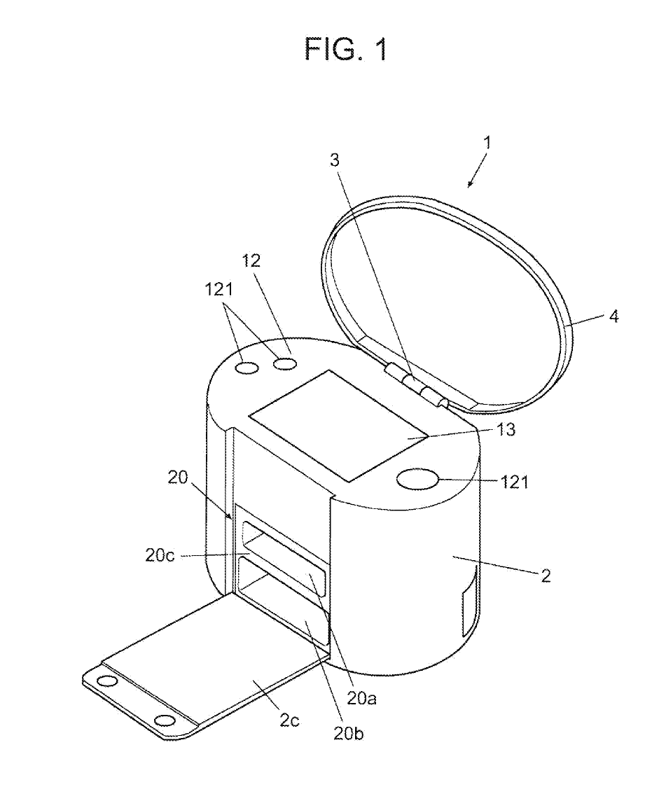

Referring to FIGS. 1 to 13, a color correction print apparatus in accordance with an embodiment of the present invention is described. In the embodiment, as the color correction print apparatus, a nail print apparatus is described. However, the color correction print apparatus of the present invention is not limited to a nail print apparatus.

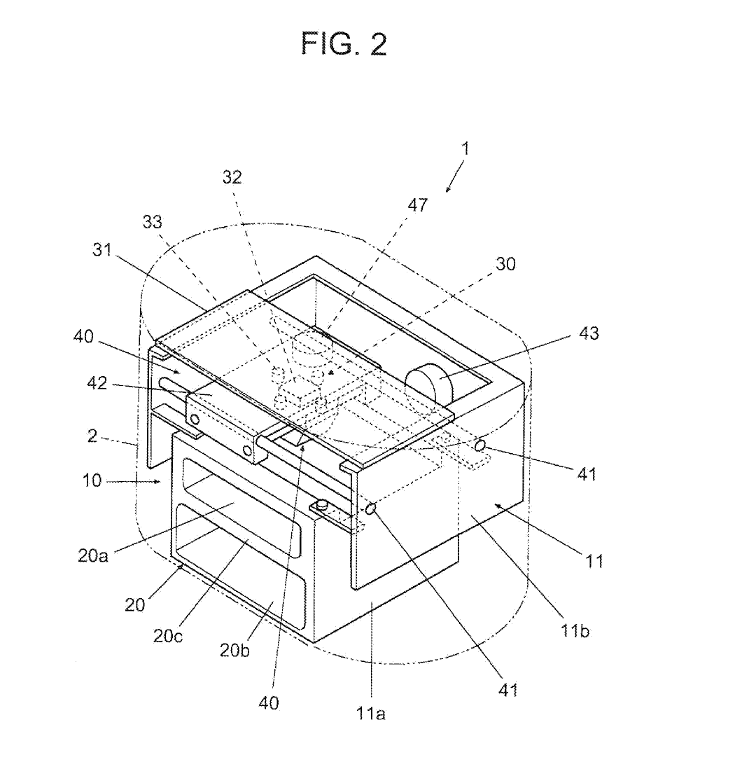

FIG. 1 is a perspective view showing the external appearance of the nail print apparatus in the embodiment. FIG. 2 is a perspective view showing the internal configuration of the nail print apparatus.

As shown in FIG. 1, a nail print apparatus 1 includes a case 2 and a cover 4. The case 2 and the cover 4 are connected with each other via a hinge 3 disposed at the rear end of the upper surface of the case 2.

The case 2 is formed to be oval in a planar view. At the front side of the case 2, an open-and-close plate 2c is provided to be able to rise and fall. The open-and-close plate 2c is connected to the case 2 via a hinge (not shown) disposed at the lower end of the front surface of the case 2. The open-and-close plate 2c is for opening and closing the front surface of the case 2.

An operation unit 12 is disposed on a top board 2f (the upper surface) of the case 2, and a display unit 13 is disposed at the approximate center of the top board 2f.

The shapes and configurations of the case 2 and the cover 4 are not limited to those exemplified here.

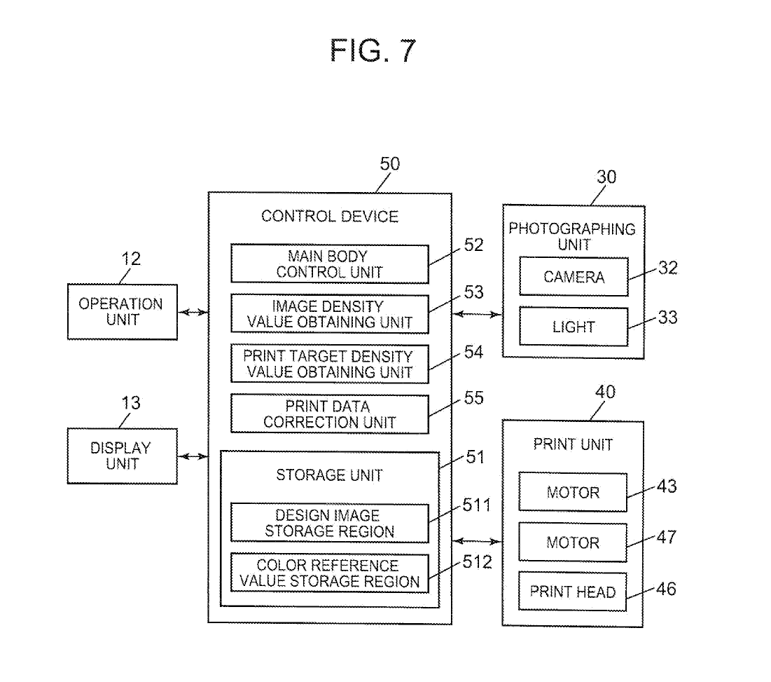

A main body 10 of the nail print apparatus 1 is housed in the case 2. The main body 10 includes a printing finger fixing unit 20, a photographing unit 30, and a print unit 40, which are shown in FIG. 2, and a control device 50 (shown in FIG. 7) as a control unit. The printing finger fixing unit 20, the photographing unit 30, the print unit 40, and the control device 50 are disposed in a machine casing 11.

The machine casing 11 includes a lower machine casing 11a and an upper machine casing 11b. The lower machine casing 11a is formed in the shape of a box. The lower machine casing 11a is disposed at a lower part in the case 2. The upper machine casing 11b is disposed over the lower machine casing 11a inside the case 2, so as to be disposed at an upper part in the case 2.

The printing finger fixing unit 20 is disposed in the lower machine casing 11a of the machine casing 11. The printing finger fixing unit 20 includes a printing finger insertion unit 20a, a non-printing finger insertion unit 20b, and a holding unit 20c which are disposed in the lower machine casing 11a.

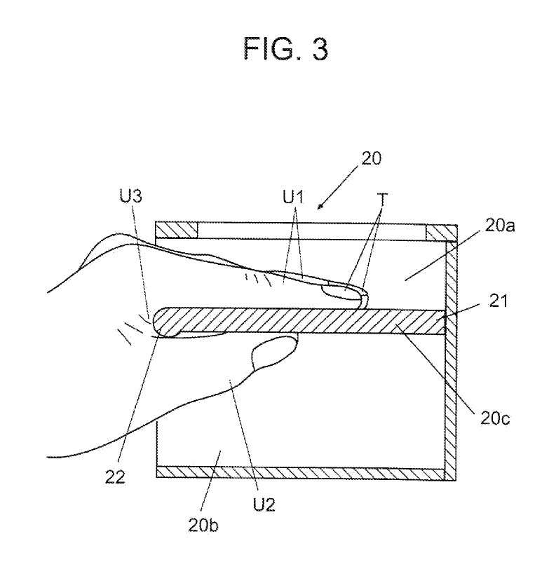

The printing finger insertion unit 20a is a finger insertion unit where fingers (printing fingers, hereinbelow) U1 having nails T on which printing is performed are inserted. (Refer to FIG. 3.) The bottom (a printing finger placement surface) functions as a finger placement unit where printing fingers U1 are placed. Photography of printing fingers U1 and printing on printing fingers U1 are performed in a state in which the printing fingers U1 are placed on the printing finger placement surface, which functions as the finger placement unit.

The non-printing finger insertion unit 20b is a finger insertion unit where fingers (non-printing fingers, hereinbelow) U2 other than the printing fingers U1 are inserted. (Refer to FIG. 3.)

The holding unit 20c is a portion which can be held by the printing fingers U1 inserted into the printing finger insertion unit 20a and the non-printing fingers U2 inserted into the non-printing finger insertion unit 20b. In the embodiment, the holding unit 20c is constituted of a partition 21 which separates the printing finger insertion unit 20a from the non-printing finger insertion unit 20b.

The upper surface of the partition 21 constitutes the flat printing finger placement surface. A bulged portion 22 is formed at an edge part of the partition 21, the edge part from which fingers are inserted. The bulged portion 22 is formed at a part which bases U3 of printing fingers U1 and non-printing fingers U2 touch when the printing fingers U1 and the non-printing fingers U2 are deeply inserted into the printing finger insertion unit 20a and the non-printing finger insertion unit 20b, respectively. As shown in FIG. 3, the cross-sectional shape of the bulged portion 22 is a circular shape that bulges downward from the lower surface of the partition 21 so that the partition 21 (the holding unit 20c) can be firmly held by the printing fingers U1 and the non-printing fingers U2 with the whole ball of each of the printing fingers U1 touching the printing finger placement surface. The cross-sectional shape of the bulged portion 22 is not limited to the circular shape, and hence the cross-sectional shape thereof can be an oval shape or a non-circular shape such as a polygonal shape.

In a case where four fingers (the index finger, the middle finger, the ring finger, and the little finger) other than the thumb of the left hand of a user are printing fingers U1, as shown in FIG. 3, the user inserts the four fingers into the printing finger insertion unit 20a, and inserts the thumb as a non-printing finger U2 into the non-printing finger insertion unit 20b. In this case, the printing fingers U1 are fixed on the holding unit 20c by the user holding the holding unit 20c with the printing fingers U1 inserted into the printing finger insertion unit 20a and the non-printing finger U2 inserted into the non-printing finger insertion unit 20b.

Furthermore, in a case where the thumb is the only printing finger U1, the user inserts the thumb (printing finger U1) into the printing finger insertion unit 20a, and inserts the other four fingers (non-printing fingers U2) into the non-printing finger insertion unit 20b. In this case, the printing finger U1 is fixed on the holding unit 20c by the user holding the holding unit 20c with the printing finger U1 and the non-printing fingers U2.

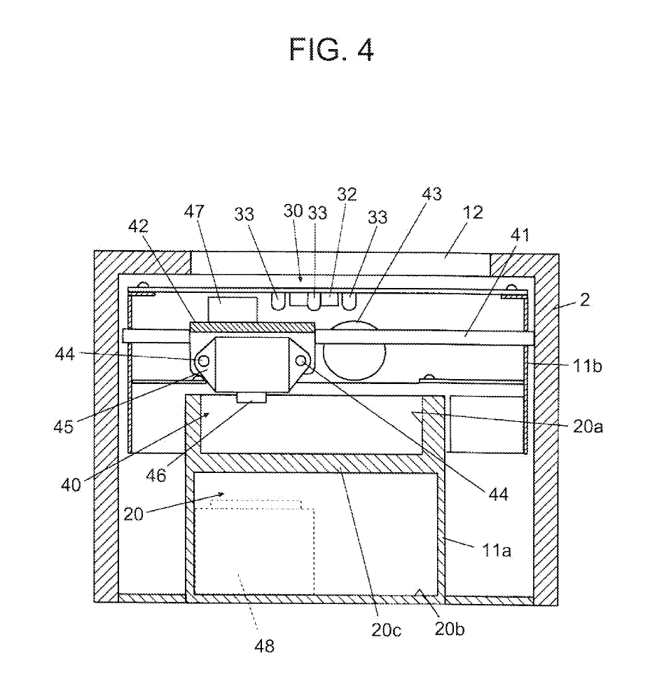

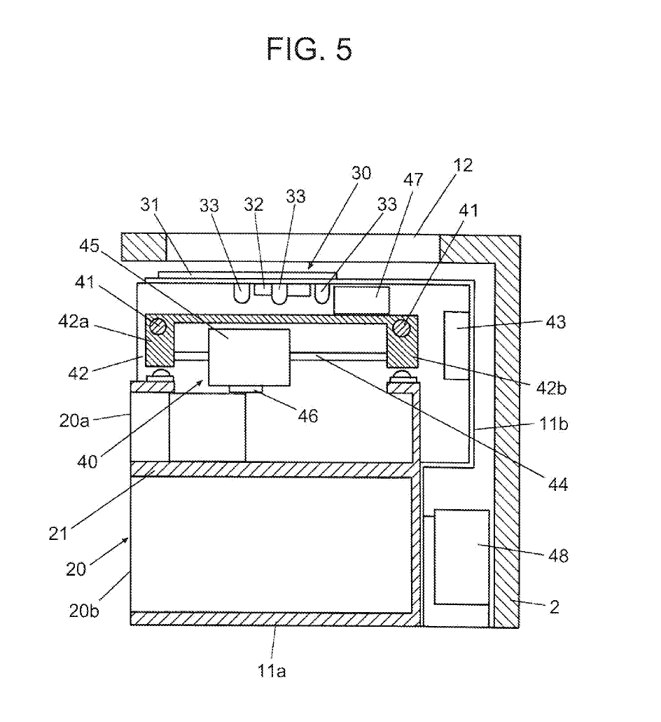

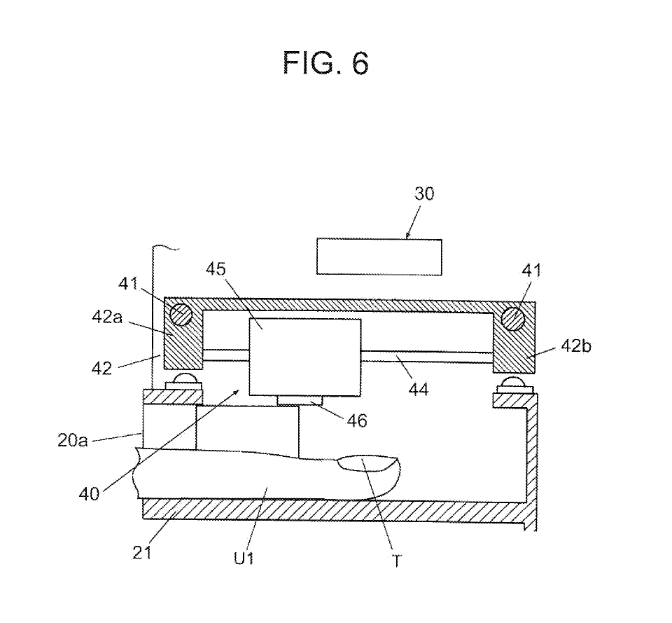

FIG. 4 is a cross-sectional view of the nail print apparatus 1, giving a view from the front. FIG. 5 is a cross-sectional view of the nail print apparatus 1, giving a view from the side. FIG. 6 is a cross-sectional view of the principle part of the nail print apparatus 1 schematically showing a positional relationship between printing fingers U1 placed on the printing finger insertion unit 20a, the photographing unit 30, and the print unit 40.

As shown in FIGS. 4 and 5, the photographing unit 30 is disposed on the upper machine casing 11b of the machine casing 11.

That is, a camera 32 having about two million pixels or more and including a built-in driver is disposed at the center of the lower surface of a substrate 31 disposed on the upper machine casing 11b. In addition, lights 33 such as white LEDs are disposed in such a way as to surround the camera 32. The photographing unit 30 includes the camera 32 and the lights 33.

As shown in FIG. 6, the photographing unit 30 is disposed in such a way as to be able to photograph printing fingers U1 placed on the printing finger placement surface of the printing finger insertion unit 20a as the finger placement unit. The photographing unit 30 illuminates the printing fingers U1 with the lights 33, and photographs the printing fingers U1 with the camera 32. The photographing unit 30 functions as a photographing unit to obtain nail images.

In the embodiment, on the basis of the nail images obtained by the photographing unit 30, a print target density value obtaining unit 54 (described below) obtains density values (print target density values or second density values, hereinbelow) of the surfaces of the nails T of the printing fingers U1. Here, the nails T are the print target, and the surfaces thereof are the printing surface. That is, the print target density value obtaining unit 54 detects, with respect to each printing finger U1, the print target density values of the constituent colors (four constituent colors of Y, M, C and K in the embodiment as described below) of the surface of the nail T on the basis of its nail image taken by the camera 32.

The photographing unit 30 is connected to a main body control unit 52 (described below) of the control device 50 to be controlled by the main body control unit 52.

A print head 46 of the print unit 40 prints images on the surfaces of the nails T of printing fingers U1 on the basis of print data of the images. When a print data correction unit 55 (described below) corrects density values (image density values or first density values, hereinbelow) of the constituent colors of the images, the print head 46 prints the images on the surfaces of the nails T of the printing fingers U1 on the basis of corrected print data having the corrected image density values.

In the embodiment, the print unit 40 is mainly disposed in the upper machine casing lib. That is, as shown in FIGS. 4 and 5, two guide rods 41 are bridged in parallel between two sideboards of the upper machine casing 11b. A main carriage 42 is attached to the guide rods 41 in such a way as to slide thereon. As shown in FIG. 5, two guide rods 44 are bridged in parallel between a front wall 42a and a back wall 42b of the main carriage 42. A secondary carriage 45 is attached to the guide rods 44 in such a way as to slide thereon. The print head 46 is mounted on the secondary carriage 45 at the center of the lower surface thereof.

In the embodiment, the print head 46 is an inkjet print head which makes ink fine droplets, and directly sprays the fine droplets to the printing surface. The recording method of the print head 46 is not limited to the inkjet method.

The print head 46 of the print unit 40 performs printing using light transmissive ink. The light transmissive ink transmits colors of the surfaces (i.e. the printing surface) of the nails T (i.e. the print target) of printing fingers U1 and colors already printed on the surfaces of the nails T so as to make various colors by being applied thereon. In the embodiment, a yellow (Y; YELLOW) ink, a magenta (M; MAGENTA) ink, a cyan (C; CYAN) ink, and a black (K; BLACK) ink are applied on top of each other to be mixed as needed, so that yellow (Y), magenta (M), cyan (C), black (K) and mixed colors of these constituent colors are made. In the embodiment, the print unit 40 includes the print head 46 having four heads respectively corresponding to the inks of the four constituent colors. However, the inks discharged from the print head 46 of the print unit 40 are not limited to the inks of the four constituent colors. The print head 46 may have more heads which respectively discharge inks of other constituent colors too.

The main carriage 42 is connected to a motor 43 via a power transmitting unit (not shown), and moves in the right-left direction along the guide rods 41 by forward-reversal rotation of the motor 43. The secondary carriage 45 is connected to a motor 47 via a power transmitting unit (not shown), and moves in the front-back direction along the guide rods 44 by forward-reversal rotation of the motor 47.

An ink cartridge 48 which supplies ink to the print head 46 is disposed in the lower machine casing 11a. The ink cartridge 48 is connected to the print head 46 via an ink supply tube (not shown), and supplies ink to the print head 46 as needed. An ink cartridge may be mounted on the print head 46 itself.

The print unit 40 includes the guide rods 41, the main carriage 42, the motor 43, the guide rods 44, the secondary carriage 45, the print head 46, the motor 47, and the ink cartridge 48. The motor 43, the print head 46, and the motor 47 of the print unit 40 are connected to the main body control unit 52 (described below) of the control device 50 to be controlled by the main body control unit 52.

The operation unit 12 is an input unit for a user to perform various inputs.

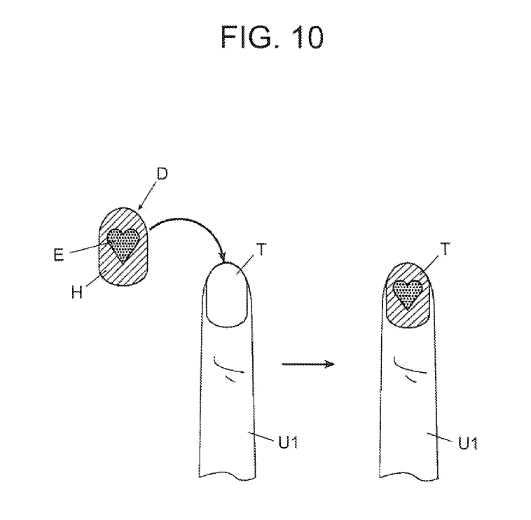

On the operation unit 12, a plurality of operation buttons 121 is disposed, such as a power button to turn on power of the nail print apparatus 1, a stop button to stop operation thereof, a design choice button to choose a design image D (shown in FIG. 10, for example) to be printed on nails T, a print start button to start printing, and other operation buttons to perform other various inputs.

In the embodiment, for example, a design choice screen (not shown) to choose a design image D is displayed on the display unit 13. A user chooses a desired design image D with the design choice button 121, whereby the design image D to be printed is chosen.

The display unit 13 is a display unit constituted of a liquid crystal panel (LCD: Liquid Crystal Display) or the like.

A touch panel may be integrally formed on the surface of the display unit 13. In this case, various inputs can be performed by touching the surface of the display unit 13 too, namely, by touch operations with a stylus pen, a finger tip or the like (not shown).

On the display unit 13, for example, nail images obtained by photographing printing fingers U1, the design choice screen to choose a design image D to be printed on nails T of printing fingers U1, thumbnail images for checking design images D, and the like are displayed.

The control device 50 is disposed, for example, on the substrate 31, which is disposed on the upper machine casing 11b. FIG. 7 is a block diagram showing a control configuration in the embodiment.

The control device 50 is a computer including a not-shown CPU (Central Processing Unit) and a storage unit 51 constituted of a ROM (Read Only Memory), a RAM (Random Access Memory) or the like (all not shown).

The storage unit 51 stores various programs such as an image density value obtaining program, a print target density value obtaining program, a print data correction program, and a print program therein. The image density value obtaining program is a program to obtain the image density values of constituent colors included in print data of design images D to be printed on the surfaces of nails T. The print target density value obtaining program is a program to obtain the print target density values of the constituent colors of the surfaces of the nails T. The print data correction program is a program to correct the image density values on the basis of the print target density values and the image density values. The print program is a program to perform printing processing. The control device 50 executes these programs, thereby controlling the components of the nail print apparatus 1.

In the embodiment, the storage unit 51 stores nail images of printing fingers U1 of a user obtained by the photographing unit 30 and the like therein.

The storage unit 51 includes a design image storage region 511 where print data of design images D are stored. The print data of each design image D includes the image density values of constituent colors (in the embodiment, four constituent colors of yellow Y, magenta M, cyan C and black K) as color information. In the following, Y, M, C and K represent yellow, magenta, cyan and black, respectively. It is not necessary that the constituent colors are four constituent colors, and hence may be three constituent colors of yellow Y, magenta M, and cyan C.

The storage unit 51 also includes a color reference value storage region 512 as a color reference value storage unit where color reference values for the constituent colors of the printing surface of the print target (the surfaces of the nails T of printing fingers U1 in the embodiment) are stored. The color reference values serve as standards to determine whether or not the print data correction unit 55 as a print data correction unit needs to perform correction (described below).

In print data, the image density values are set in such away that color development is most suitable when printing with light transmissive ink is performed on the color which is regarded as the normal color for the printing surface of the print target (the normal color being light pink in the case where the printing surface is the surfaces of nails T, and white in the case where the printing surface is printing paper, for example). In the embodiment, the print data correction unit 55 does not always perform correction even when there is a difference between the density value (print target density values) of a constituent color of the actual color of the printing surface and the density value of the constituent color of its normal color. In the embodiment, the print data correction unit 55 performs correction only when the difference between the density value of a constituent color of the actual color of the printing surface and the density value of the constituent color of its normal color is equal to or more than a predetermined density values. The color reference values serve as tolerances or thresholds to determine whether or not to perform correction.

The color reference values are set for the respective constituent colors, for example, Y:10, M:10, C:10 and K:10. The color reference values herein are examples, and hence not limited thereto. The color reference values can be appropriately set for the respective constituent colors. For example, the color reference values may be different values from each other. In a case where a plurality of print targets (natural nails T on which nail printing has not been performed and coated nails T on which nail printing has previously been performed previously, for example) is expected, and print data are respectively prepared for the print targets, the color reference values may be respectively set and stored for the print targets.

In the embodiment, the control device 50 includes functional units such as the main body control unit 52, the image density value obtaining unit 53, the print target density value obtaining unit 54, and the print data correction unit 55. The functional units included in the control device 50 are not limited thereto, and hence other functional units, such as a nail region detection unit which detects the region of a nail T from a nail image, may be included in the control device 50 too.

The main body control unit 52 is a functional unit which controls the nail print apparatus 1 overall.

In the embodiment, the main body control unit 52 functions as a photography control unit which controls the photographing unit 30 so that the photographing unit 30 photographs printing fingers U1 of a user to obtain nail images. Furthermore, the main body control unit 52 functions as a print control unit which outputs print data (described below) to the print unit 40, and which controls the print unit 40 so that the print unit 40 performs printing on nails T in accordance with the print data.

The image density value obtaining unit 53 obtains the image density values of the constituent colors (i.e. Y, M, C and K) included in the print data of an image (design image D) to be printed on the surfaces of the nails T of printing fingers U1 of a user. The image density values obtained by the image density value obtaining unit 53 are stored in the storage unit 51.

The image density values may be obtained for each image, for each pixel of each image, or for each region of each image, such as a pattern region or a background region. In the embodiment, the image density values are obtained for each image (design image D).

The print target density value obtaining unit 54 obtains the print target density values of the constituent colors of the surfaces of the nails T of printing fingers U1 of a user from their nail images taken by the photographing unit 30.

The print target density value obtaining unit 54 detects the print target density values of the constituent colors of the region of the nail T of a printing finger U1 from its nail image, for example Y:20, M:10, C:0 and K:0. The print target density values obtained by the print target density value obtaining unit 54 are stored in the storage unit 51.

The print data correction unit 55 corrects the image density values obtained by the image density value obtaining unit 53 on the basis of their respective print target density values obtained by the print target density value obtaining unit and the image density values.

In the embodiment, the print data correction unit 55 finds, with respect to all the constituent colors, differential values between their respective print target density values obtained by the print target density value obtaining unit 54 and their respective image density values obtained by the image density value obtaining unit 53, and corrects the print data on the basis of the differential values.

The print data correction unit 55 determines whether or not to perform the correction by comparing, with respect to all the constituent colors, the print target density values obtained by the print target density value obtaining unit 54 with their respective color reference values stored in the color reference value storage region 512, and only with respect to the constituent colors having the print target density values being equal to or more then their respective color reference values, corrects their respective image density values.

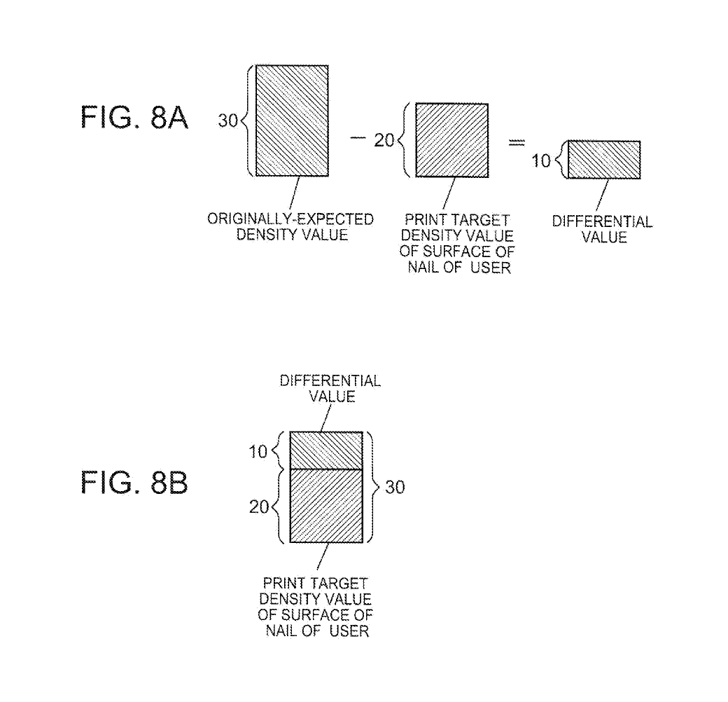

More specifically, for example, if the image density values are Y:30, M:10, C:10 and K10, the print target density values are Y:20, M:0, C:0 and K:0, and the color reference values are Y:10, M:10, C:10 and K10, among the print target density values, only the print target density value of Y is equal to or more than the color reference value as a threshold (or a tolerance), namely, Y:20>Y:10. In this case, the image density value of Y is Y:30, and the print target density value of Y is Y:20. Hence, if the print data is printed without the correction, Y:30 is applied onto Y:20, which has already been on the surface of the nail T. Consequently, the density value (final density value) of Y after printing is Y:50 which greatly exceeds the density value (image density value) originally expected. If the actual color of the nail T is taken into account, as shown in FIGS. 8A and 8B, the density value of Y is Y:10 short to reach the originally-expected density value of Y (Y:30 in the embodiment). The Y:10 is the differential value between the density value (print target density value) of Y of the nail T (Y:20 in the embodiment) and the originally-expected density value (image density value) of Y (Y:30). Therefore, the print data correction unit 55 finds the differential value between the print target density value (Y:20) and the image density value (Y:30) only for Y, and performs the correction so that the differential value (Y:10 in the embodiment) is used as the image density value of Y. As a result, the image density values of the corrected print data are Y:10, M:10, C:10 and K10, and printing is performed on the basis of the corrected print data.

As another example, if the image density values are Y:50, M:40, C:40 and K20, the print target density values are Y:20, M:20, C:20 and K:10, and the color reference values are Y:10, M:10, C:10 and K10, the print target density values of all the constituent colors of the nail T are equal to or more than the color reference values as thresholds (or tolerances). In this case, the print data correction unit 55 finds the difference values between the print target density values and the image density values for all the constituent colors, and performs the correction so that the differential values are used as the image density values, respectively. As a result, the image density values of the corrected print data are Y:30, M:20, C:20 and K10, and printing is performed on the basis of the corrected print data.

As another example, if the image density values are Y:50, M:30, C:40 and K20, the print target density values are Y:20, M:10, C:7 and K:5, and the color reference values are Y:10, M:10, C:10 and K10, only the print target density values of Y and M of the nail T are equal to or more than the color reference values as thresholds (or tolerances). In this case, the print data correction unit 55 finds the difference values between the print target density values and the image density values only for Y and M, and performs the correction so that the differential values of Y and M are used as the image density values of Y and M, respectively. As a result, the image density values of the corrected print data are Y:30, M:20, C:40 and K20, and printing is performed on the basis of the corrected print data. Note that, in this case, the print target density values of C and K are C:7 and K:5, respectively. Hence, when printing is performed with the image density values of C and K kept as they are, the final density values of C and K are C:47 and K:25. However, as to a constituent color having the print target density value being less than its color reference value, even if the final density value is somewhat more than its originally-expected density value, it is regarded as being within an acceptable error range.

As another example, if the image density values are Y:50, M:30, C:20 and K20, the print target density values are Y:8, M:5, C:30 and K:7, and the color reference values are Y:10, M:10, C:10 and K10, the print target density value of C is equal to or more than the color reference value as a threshold (or a tolerance), and also more than the image density value of C. In this case, namely, in the case where the differential value between the print target density value and the image density value is negative, because it is impossible to perform the correction so that a value which reduces the print target density value is used as the image density value, the print data correction unit 55 performs the correction so that C:0 is used as the image density value of C. As a result, the image density values of the corrected print data are Y:50, M:30, C:0 and K20, and printing is performed on the basis of the corrected print data.

When the correction is performed by the print data correction unit, the corrected print data is outputted to the print unit 40. Then, the print unit 40 performs printing on the surface of the nail T on the basis of the corrected print data. When the correction is not performed, the original print data is outputted to the print unit 40. Then, the print unit 40 performs printing on the surface of the nail T on the basis of the original print data.

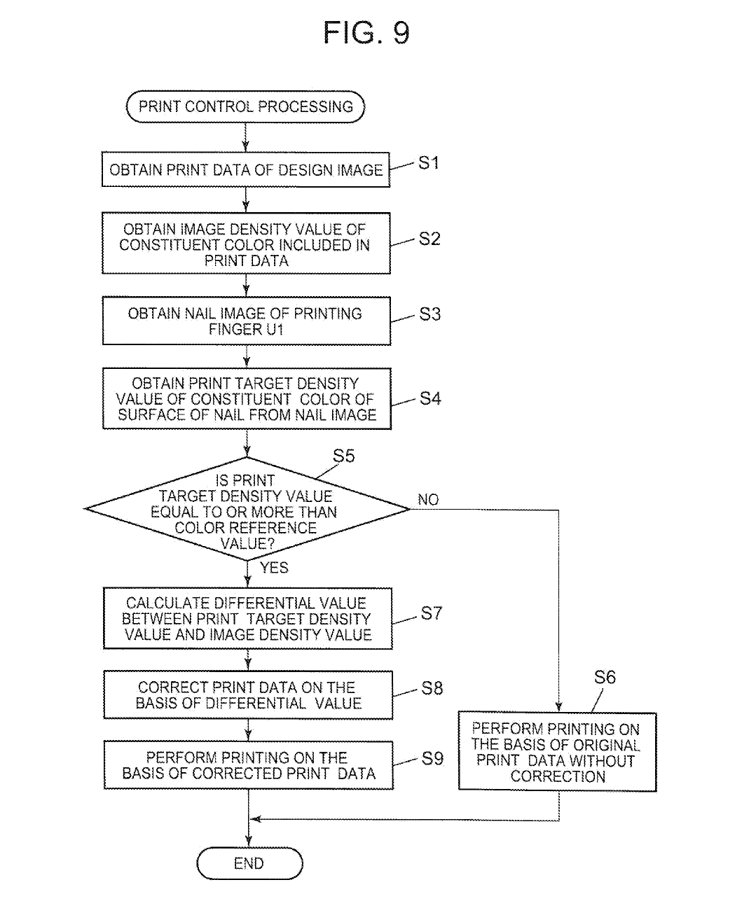

Next, referring to FIGS. 9 to 13, print control processing performed by the nail print apparatus 1 in the embodiment is described.

In order to perform printing with the nail print apparatus 1, a user first turns on the power button 121 to start the control device 50.

The main body control unit 52 displays the design choice screen on the display unit 13, and the user operates, for example, the design choice button 121 of the operation unit 12 to choose a desired design image D from a plurality of design images D displayed on the design choice screen, and accordingly a choice instruction signal is outputted from the operation unit 12 so that one desired design image D is chosen.

When the design image D to be printed is chosen, as shown in FIG. 9, the image density value obtaining unit 53 reads print data of the design image D from the design image storage region 511 of the storage unit 51 to obtain the print data (Step 51), and obtains the image density values of constituent colors included in the print data (Step S2).

Next, the user inserts printing fingers U1 into the printing finger insertion unit 20a and non-printing fingers U2 into the non-printing finger insertion unit 20b, and operates the print start button 121 with the printing fingers U1 fixed.

For example, if the user would like to have printing on the nails T of the index finger, the middle finger, the ring finger and the little finger of his/her left hand, as shown in FIG. 3, the user inserts the index finger, the middle finger, the ring finger and the little finger into the printing finger insertion unit 20a with the fingers horizontally aligned, and inserts the thumb into the non-printing finger insertion unit 20b, and holds the holding unit 20c with the fingers inserted into the printing finger insertion unit 20a and the thumb inserted into the non-printing finger insertion unit 20b. Consequently, the fingers as the printing fingers U1 are fixed on the printing finger placement surface.

When an instruction is inputted from the print start button 121, the control device 50 controls the photographing unit 30 before starting print operation so that the photographing unit 30 photographs all the printing fingers U1. Consequently, nail images of the printing fingers U1 are obtained (Step S3). When the nail images are obtained, the print target density value obtaining unit 54 obtains the print target density values of the constituent colors of the surfaces of the nails T from the nail images (Step S4).

The print data correction unit 55 reads color reference values for their respective constituent colors of the surfaces of the nails T from the color reference value storage region 512 of the storage unit 51, and determines whether or not the print target density values obtained by the print target density value obtaining unit 54 are equal to or more than their color reference values, respectively (Step S5). When it is determined that none of the print target density values are equal to or more than their color reference values (Step S5; NO), the print data correction unit 55 does not perform the correction, and the original print data is outputted to the print unit 40 as it is, so that the print unit 40 performs printing on the basis of the original print data (Step S6).

That is, for example, as shown in FIG. 10, when no coloring or the like is performed on the nails T of the printing fingers U1 of the user, and none of the print target density values of Y, M, C and K are equal to or more than their color reference values, the design image D is printed on the nails T on the basis of the original print data.

On the other hand, when it is determined that at least one of the print target density values is equal to or more than its color reference value (Step S5; YES), the print data correction unit 55 calculates the differential value between the print target density value and the image density value for the constituent color having the print target density value being equal to or more than its color reference value (Step S7). Then, the print data correction unit 55 corrects the print data in such a way that the calculated differential value is the image density value of the constituent color (Step S8). Then, the corrected print data is outputted to the print unit 40, and the print unit 40 performs printing on the basis of the corrected print data (Step S9).

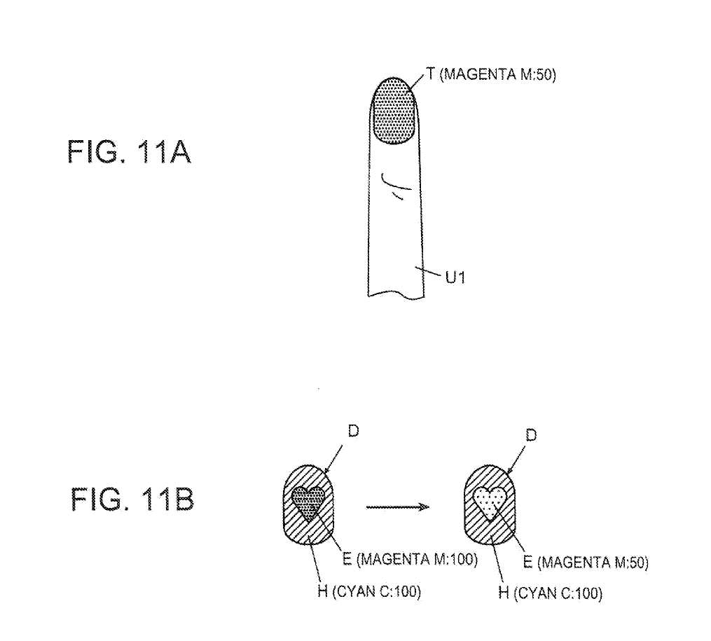

For example, as shown in FIGS. 11B, 12B and 13B, if the chosen design image D is constituted of a dark cyan (C:100) background part H and a dark magenta (M:100) heart pattern part E, print data thereof is corrected in accordance with the colors of the surfaces of nails T of a user as follows.

That is, for example, as shown in FIG. 11A, in a case where the surface of a nail T of a user has been painted with light magenta (M:50) previously, as shown in FIG. 11B, with respect to the heart pattern part E of the design image D, the print data correction unit 55 corrects the print data so that the differential value of M (M:50) between the print target density value of M (M:50) and the image density value of M (M:100) is used as the image density value of M. As a result, when printing is performed on the surface of the nail T on the basis of the corrected print data, the originally-expected density value of M (M:100) for the heart pattern part E can be realized.

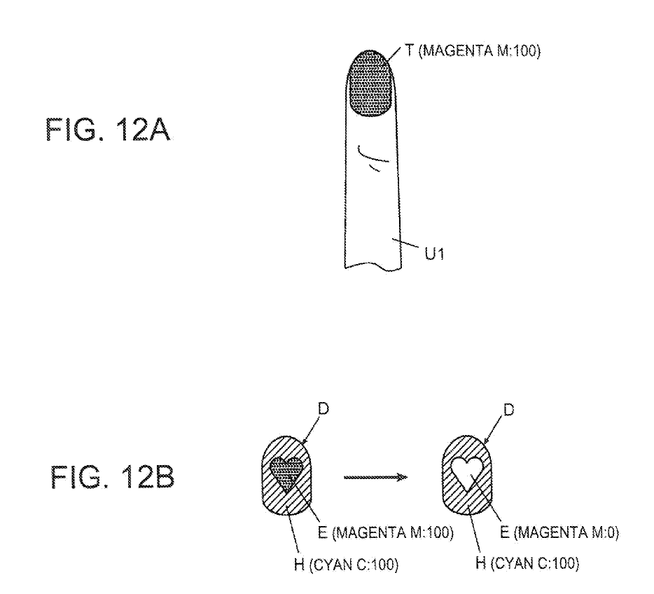

Furthermore, for example, as shown in FIG. 12A, in a case where the surface of a nail T of a user has been painted with dark magenta (M:100) previously, as shown in FIG. 12B, with respect to the heart pattern part E of the design image D, the print data correction unit 55 corrects the print data so that the differential value of M (M:0) between the print target density value of M (M:100) and the image density value of M (M:100) is used as the image density value of M. As a result, when printing is performed on the surface of the nail T on the basis of the corrected print data, the originally-expected density value of M (M:100) for the heart pattern part E can be realized.

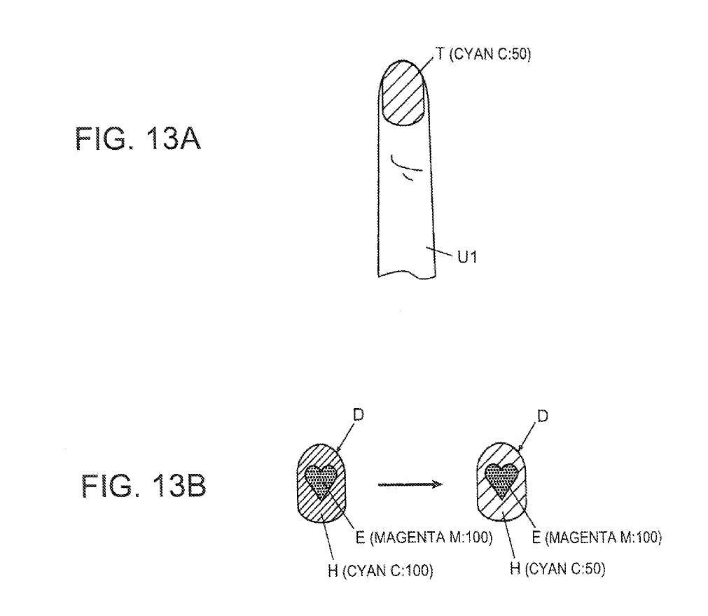

Furthermore, for example, as shown in FIG. 13A, in a case where the surface of a nail T of a user has been painted with light cyan (C:50) previously, as shown in FIG. 13B, with respect to the background part H of the design image D, the print data correction unit 55 corrects the print data so that the differential value of C (C:50) between the print target density value of C (C:50) and the image density value of C (C:100) is used as the image density value of C. As a result, when printing is performed on the surface of the nail T on the basis of the corrected print data, the originally-expected density value of C (C:100) for the background part H can be realized.

As described above, the nail print apparatus 1 in the embodiment obtains the image density value of each constituent color included in print data of a design image D to be printed on the surface of the nail T of a printing finger U1 of a user, namely, on the printing surface of the print target; obtains the print target density value of each constituent color of the surface of the nail T; corrects the image density value on the basis of the print target density value and the image density value with respect to each constituent color; and prints the design image D on the surface of the nail T on the basis of the corrected print data using light transmissive ink. Accordingly, even if some printing, coloring or the like has previously been performed on the surface of the nail T of a printing finger U1 of a user, and a design image D needs to be printed on that surface of the nail T, the actual color of which is not the normal color for the surface of nails T such as light pink, the design image D can be printed thereon with color development as expected, by taking the actual color of the surface of the nail T into account.

Furthermore, the print data correction unit 55 finds, with respect to each constituent color, the differential value between the print target density value obtained by the print target density value obtaining unit 54 and the image density value obtained by the image density value obtaining unit 53, and corrects the image density value on the basis of the differential value. Accordingly, the densities of inks of the constituent colors used for printing can be adjusted by taking the color of the surface of the nail T of a printing finger U1 of a user into account. Hence, if some coloring has previously been performed on the surface of a nail T, unnecessary application of the inks can be prevented by performing printing utilizing the color of the surface of the nail T, and accordingly desired color development can be efficiently realized.

Furthermore, the print data correction unit 55 compares, with respect to each constituent color, the print target density value obtained by the print target density value obtaining unit 54 with the color reference value stored in the color reference value storage region 512, and corrects, only for the constituent color having the print target density value being equal to or more than the color reference value, the image density value. Accordingly, if the difference between the print target density value of a constituent color of the actual color of the surface of a nail T and the density value of the constituent color of the normal color for the surfaces of nails T, the normal color which the print data originally assumes, is within the range which does not influence the finished product (i.e. the printed design image Don the surface of the nail T) so much, the printing processing can be performed without the correction, and hence the process efficiency can be improved.

In the embodiment, the color reference values are stored as thresholds used to determine whether or not to perform the correction, and only when the print target density value of a constituent color of the printing surface (the surfaces of the nails T in the embodiment) is equal to or more than its color reference value, the image density value of the constituent color is corrected. However, setting the color reference values and determining whether or not to perform the correction are not essential in the present invention, and hence the present invention may be configured not to perform these. In this case, when the print target density value of a constituent color of the actual color of the printing surface of the print target (the surface of a nail T of a user, for example) is different even a little from the density value of the constituent color of the color which is regarded as the normal color for the printing surface of that print target (the surface of a natural nail T), the image density value is always corrected.

In the embodiment, the nail print apparatus 1, which performs printing on the surfaces of nails T of printing fingers U1 as the printing surface of the print target, is described as the color correction print apparatus of the present invention. However, the color correction print apparatus of the present invention is not limited to the nail print apparatus 1. For example, the color correction print apparatus of the present invention may be applied to a print apparatus which performs printing on various types of printing paper. In this case, the correction is performed in accordance with the density value (print target density value) of each constituent color of the surface of the printing paper.

In a case where printing is expected to be performed on a plurality of print targets, and print data are respectively prepared for the print targets in accordance with the colors of their respective printing surfaces, the color reference values may be respectively prepared for the print targets too. For example, if print data are respectively prepared for white printing paper and light beige recycled paper, the color reference values may be respectively prepared for the white printing paper and the light beige recycled paper too. Then, the color reference values can be selectively used in accordance with the print target.

In the embodiment, the print data correction unit 55 corrects the image density value of each constituent color of a design image D obtained by the image density value obtaining unit 53 on the basis of the print target density value of each constituent color of the printing surface (the surface of a nail T in the embodiment) obtained by the print target density value obtaining unit 54 and the image density value. However, the correction performed by the print data correction unit 55 is not limited to the correction on the image density values.

Furthermore, the method used by the print data correction unit 55 to correct print data is not limited to finding the differential value between the print target density value of each constituent color of the printing surface (the surface of a nail T in the embodiment) and the image density value of each constituent color of a design image D. For example, the print data correction unit 55 may correct print data on the basis of color information other than the image density values and the print target density values.

In the embodiment, the design image storage region 511 and the color reference value storage region 512 are provided in the storage unit 51 of the control device 50. However, this is not a limit, and hence another storage unit may be provided for the design image storage region 511 and the color reference value storage region 512.

In the embodiment, the nail print apparatus 1 performs printing by four printing fingers being inserted thereinto at a time. However, this is not a limit. The present invention is applicable to a print apparatus which performs printing by printing fingers being inserted thereinto one by one.

Needless to say, the present invention is not limited to the embodiment in other aspects too, and hence can be appropriately modified without departing from the scope of the present invention.

The embodiment disclosed above is an example in all the aspects and the present invention is not limited to the embodiment. Therefore, the scope of the invention is intended to be limited not by the above description but solely by the scope of the claims and equivalents to the claims within the meaning and range thereof, and all the modifications are to be included.

According to a first aspect of the preferred embodiment of the present invention, there is provided a color correction print apparatus including: a print head which prints an image on a printing surface; and a print data correction unit which corrects a first density value of a constituent color included in the image on the basis of a second density value of the constituent color of the printing surface and the first density value.

Preferably, the color correction print apparatus according further includes a print control unit which makes the print head print a corrected image including the corrected first density value on the printing surface.

Preferably, the color correction print apparatus further includes: an image density value obtaining unit which obtains the first density value; and a print target density value obtaining unit which obtains the second density value before the print head prints the image on the printing surface, wherein the print head prints the image using light transmissive ink.

Preferably, in the color correction print apparatus, the print data correction unit finds a differential value between the first density value and the second density value to correct the first density value on the basis of the differential value.

Preferably, the color correction print apparatus further includes a color reference value storage unit where a color reference value for the constituent color of the printing surface is stored, the color reference value being used to determine whether or not the print data correction unit corrects the first density value, wherein the print data correction unit compares the second density value with the color reference value to correct the first density value when the second density value is equal to or more than the color reference value.

Preferably, in the color correction print apparatus, the constituent color includes yellow, magenta and cyan.

According to a second aspect of the preferred embodiment of the present invention, there is provided a print control method including: obtaining a first density value of a constituent color included in an image to be printed on a printing surface; obtaining a second density value of the constituent color of the printing surface; and correcting the first density value on the basis of the first density value and the second density value.

Preferably, the print control method further includes printing a corrected image on the printing surface using light transmissive ink, the corrected image including the corrected first density value.

Preferably, the print control method further includes finding a differential value between the first density value and the second density value to correct the first density value on the basis of the differential value.

Preferably, the print control method further includes comparing the second density value with a color reference value indicating a standard color for the constituent color of the printing surface to correct the first density value when the second density value is equal to or more than the color reference value.

Preferably, in the print control method, the constituent color includes yellow, magenta and cyan.

This application is based upon and claims the benefit of priority under 35 USC 119 of Japanese Patent Application No. 2011-208453 filed on Sep. 26, 2011, the entire disclosure of which, including the description, claims, drawings, and abstract, is incorporated herein by reference in its entirety.

What is claimed is:

1. A color correction print apparatus comprising:
a print head which prints an image on a printing surface; and
a print data correction unit which corrects a first density value of a constituent color included in the image on the basis of a second density value of the constituent color of the printing surface and the first density value.

2. The color correction print apparatus according to claim 1 further comprising a print control unit which makes the print head print a corrected image including the corrected first density value on the printing surface.

3. The color correction print apparatus according to claim 1 further comprising:
an image density value obtaining unit which obtains the first density value; and
a print target density value obtaining unit which obtains the second density value before the print head prints the image on the printing surface, wherein
the print head prints the image using light transmissive ink.

4. The color correction print apparatus according to claim 1, wherein the print data correction unit finds a differential value between the first density value and the second density value to correct the first density value on the basis of the differential value.

5. The color correction print apparatus according to claim. 1 further comprising a color reference value storage unit where a color reference value for the constituent color of the printing surface is stored, the color reference value being used to determine whether or not the print data correction unit corrects the first density value, wherein
the print data correction unit compares the second density value with the color reference value to correct the first density value when the second density value is equal to or more than the color reference value.

6. The color correction print apparatus according to claim 1, wherein the constituent color includes yellow, magenta and cyan.

7. A print control method comprising:
obtaining a first density value of a constituent color included in an image to be printed on a printing surface;
obtaining a second density value of the constituent color of the printing surface; and
correcting the first density value on the basis of the first density value and the second density value.

8. The print control method according to claim 7 further comprising printing a corrected image on the printing surface using light transmissive ink, the corrected image including the corrected first density value.

9. The print control method according to claim 7 further comprising finding a differential value between the first density value and the second density value to correct the first density value on the basis of the differential value.

10. The print control method according to claim 7 further comprising comparing the second density value with a color reference value indicating a standard color for the constituent color of the printing surface to correct the first density value when the second density value is equal to or more than the color reference value.

11. The print control method according to claim 7, wherein the constituent color includes yellow, magenta and cyan.
